(19) United States
(12) Patent Application Publication
(10) Pub. No.: US 2024/0147140 A1
(43) Pub. Date: May 2, 2024

(54) ELECTROACOUSTIC TRANSDUCER, AUDIO INSTRUMENT, AND WEARABLE DEVICE

(71) Applicant: Wataru YOKOTA, Kanagawa (JP)

(72) Inventor: Wataru YOKOTA, Kanagawa (JP)

(21) Appl. No.: 18/384,383

(22) Filed: Oct. 27, 2023

(30) Foreign Application Priority Data
Nov. 1, 2022 (JP) 2022-175802

(51) Int. Cl. H04R 1/28

(52) U.S. Cl. CPC H04R 1/2811; H04R 2400/11; H04R 2499/11

(57) ABSTRACT

To efficiently improve a sound pressure level of an electroacoustic transducer, an electroacoustic transducer according to an aspect of the disclosed technique includes a vibrating unit, a plurality of driving units situated on the vibrating unit and configured to drive the vibrating unit; and a frame positioned along a circumference of the vibrating unit is a plan view perspective. In the plan view perspective, the vibrating unit is attached on the frame by first and second attaching sides thereof situated oppositely. The driving units include first and second driving units situated at positions overlapping the first and second attaching sides. A length of the first driving unit on the vibrating unit in a direction parallel with a line segment that connects a midpoint of the first attaching side and a midpoint of the second attaching side is less than or equal to 35% of a length of the line segment.

### CROSS-REFERENCE TO RELATED APPLICATION

The present application is based on and claims priority under 35 U.S.C. § 119 to Japanese Patent Application No. 2022-175802, filed on Nov. 1, 2022, the contents of which are incorporated herein by reference in their entirety.

### BACKGROUND OF THE INVENTION

### I. Field of the Invention

The present invention relates to an electroacoustic transducer, an audio instrument, and a wearable device.

### 2. Description of the Related Art

In recent years, audio instruments such as earphones have been being developed for such purposes as listening to music or watching moving images, and teleconferences. In audio instruments, speaker drivers, which are sound producing means, are realized by, for example, Micro Electra Mechanical System (MEMS) techniques. Speaker drivers that are often selected are, for example, piezoelectric driving MEMSs that utilize, for example, voltage application-driven shrinkage of piezoelectric films that are made of, for example, lead zirconate titanate (PZT) and are easy to miniaturize. These speaker drivers are required to be able to output a sound pressure level of 100 dB or higher at 1 kHz at a low voltage (<10V), and to have a flat pressure level over a wide frequency range.

United States Patent Application Publication No. 2020/0178000 describes an electroacoustic transducer including a square-shaped piezoelectric MEMS in which a PZT film is formed on a silicon layer.

What often done to improve the sound pressure level of existing piezoelectric driving MEMS-employing electroacoustic transducers per voltage include making the silicon thickness of the PENS portion small to improve ease of driving the surface of the electroctcoustic transducer and to increase the volume velocity (amount of amplitude displacement). However, such a method can impart a volume velocity to only some part of the center portion of the silicon surface apart from a fixed end of the silicon surface, and has a problem that the sound pressure level cannot be improved efficiently.

### SUMMARY CF THE INVENTION

An electroacoustic transducer according to an embodiment of the disclosed technique includes a vibrating unit, a plurality of driving units situated on the vibrating unit and configured to drive the vibrating unit, and a frame positioned along a circumference of the vibrating unit in a plan view perspective. In the plan view perspective, the vibrating unit is attached on the frame by a first attaching side thereof and a second attaching side thereof positioned at an opposite side to the first attaching side. The driving units include a first driving unit situated at a position over the first attaching side, and a second driving unit situated at a position overlapping the second attaching side. A length of the first driving unit on the vibrating unit in a direction parallel with a line segment that connects a midpoint of the first attaching side and a midpoint of the second attaching side is less than or equal to 35% of a length of the line segment.

### BRIEF DESCRIPTION OF THE DRAWINGS

FIG. 1 is a plan view illustrating an example of a configuration of an electroacoustic transducer according to a first embodiment;

FIG. 2 is a plan view illustrating a first modified example of the first embodiment;

FIG. 3 is a plan view illustrating a second modified example of the first embodiment;

FIG. 4 is a cross-sectional view taken along an alternate long and short dash line A-A′ of FIG. 1;

FIG. 5 is a view illustrating shape parameters of the configuration illustrated in FIG. 1.

FIG. 6 is a drawing illustrating a relationship between parameters and a sound pressure level according to an embodiment;

FIG. 7 is a drawing illustrating a behavior of a vibrating unit when Lp/L is 0.49;

FIG. 8 is a drawing illustrating a behavior of a vibrating unit when Lp/L is 0.25;

FIG. 9 is a plan view illustrating a third modified example of the first embodiment;

FIG. 10 is a drawing illustrating a relationship between parameters and a sound pressure level according to the third modified example of the first embodiment;

FIG. 11 is a plan view illustrating an example of a configuration of an electroacoustic transducer according to a second embodiment;

FIG. 12 is a plan view illustrating an example of a configuration of an electroacoustic transducer according to a third embodiment;

FIG. 13 is a plan view illustrating a first modified example of the third embodiment;

FIG. 14 is a plan view illustrating a second modified example of the third embodiment;

FIG. 15 is a plan view illustrating an example of a configuration of an electroacoustic transducer according to a fourth embodiment;

FIG. 16A is a plan view illustrating displacement of a vibrating unit and a frame in the first embodiment;

FIG. 16B is a cross-sectional view taken along an alternate long and short dash line B-B′ of FIG. 16A;

FIG. 17A is a plan view illustrating a first modified example of the fourth embodiment;

FIG. 17B is a cross-sectional view taken along an alternate long and short dash line C-C′ of FIG. 17A;

FIG. 18 is a plan view illustrating a second modified example of the fourth embodiment;

FIG. 19 is a plan view illustrating a third modified example of the fourth embodiment;

FIG. 20 is a view illustrating an eyeglasses-type wearable device 2000;

FIG. 21 is a view illustrating a wristwatch-type wearable device 3000; and

FIG. 22 is a view illustrating an earphone 4000.

### DESCRIPTION OF THE EMBODIMENTS

The present invention was made in view of the point described above, and an object of the present invention is to provide an electroacoustic transducer that can improve a sound pressure level more efficiently.

The disclosed technique can improve the sound pressure level of an electroacoustic transducer efficiently.

### First Embodiment

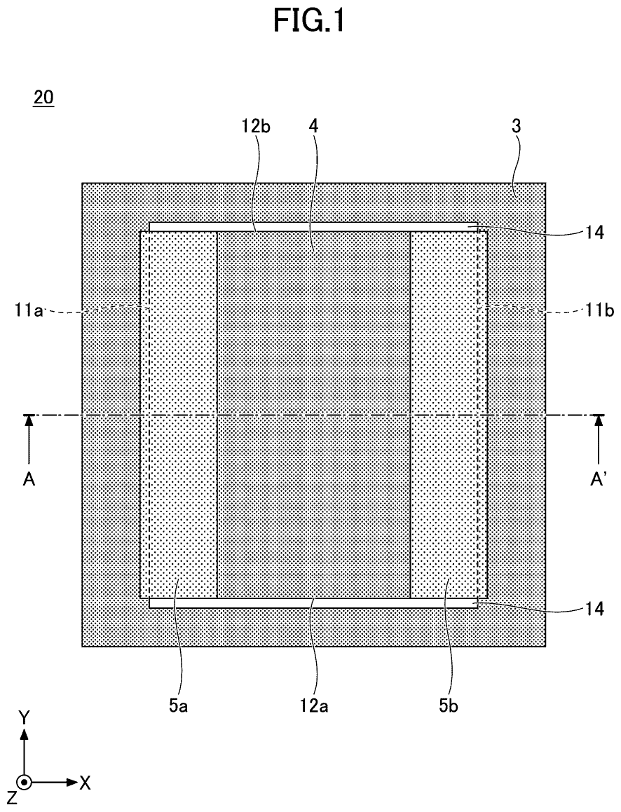

FIG. 1 is a plan view illustrating an example of a configuration of an electroacoustic transducer according to a first embodiment. As illustrated in FIG. 1, an electroacoustic transducer is a speaker driver of a piezoelectrically driving Micro Electro Mechanical System (MEMS)-type. The electroacoustic transducer 20 includes a vibrating unit 4, a frame 3, a piezoelectric driving unit 5a, and a piezoelectric driving unit 5b. When the piezoelectric driving unit 5a and the piezoelectric driving unit 5b are referred to collectively, they may be referred to as piezoelectric driving units 5.

The vibrating unit 4 has a square shape. The frame 3 is provided to enclose the vibrating unit 4 in a plan view perspective, and is attached on the vibrating unit 4. The frame 3 has a rectangular frame shape. The piezoelectric driving units 5 are situated on the frame 3 and the vibrating unit 4, and are configured to drive the vibrating unit 4. The piezoelectric driving units 5 have a rectangular shape. Seeing an a plan view perspective means seeing an object in a direction normal to the top surface of the vibrating unit 4.

For a referential purpose, FIG. 1 illustrates an X axis, a Y axis, and a Z axis that are orthogonal to one another. The X axis direction and the Y axis direction are directions orthogonal to each other in a plane that is parallel with the top surface of the vibrating unit 4. The Z axis direction is a direction orthogonal to the X axis direction and the Y axis direction. In other words, the Z axis direction is a direction normal to the top surface of the vibrating unit 4. Here, the electroacoustic transducer 20 in a plan view perspective means the electroacoustic transducer 20 represented in the XY plane of FIG. 1. An X axis, a Y axis, and a Z axis that correspond to FIG. 1 may also be illustrated in other drawings.

In a plan view perspective, the vibrating unit 4 is attached on the frame 3 by an attaching side 11a thereof and an attaching side lib thereof positioned at an opposite side to the attaching side 11a (when the attaching side 11a and the attaching side 11b are referred to collectively, they may be referred to as attaching sides 11). The attaching sides 11 are parallel with the Y axis direction. Sides 12a and 12b of the vibrating unit 4 that are not attached on the frame 3 (hereinafter, referred to as open sides 12a and 12b, and may be referred to as open sides 12 when they are referred to collectively) are open through slits 14. The slits 14 are provided along the open sides 11a and 12b, and extend in a direction orthogonal to the attaching sides 11a and 11b. The slits 14 can inhibit destruction due to collision of the vibrating unit 4 and the frame 3.

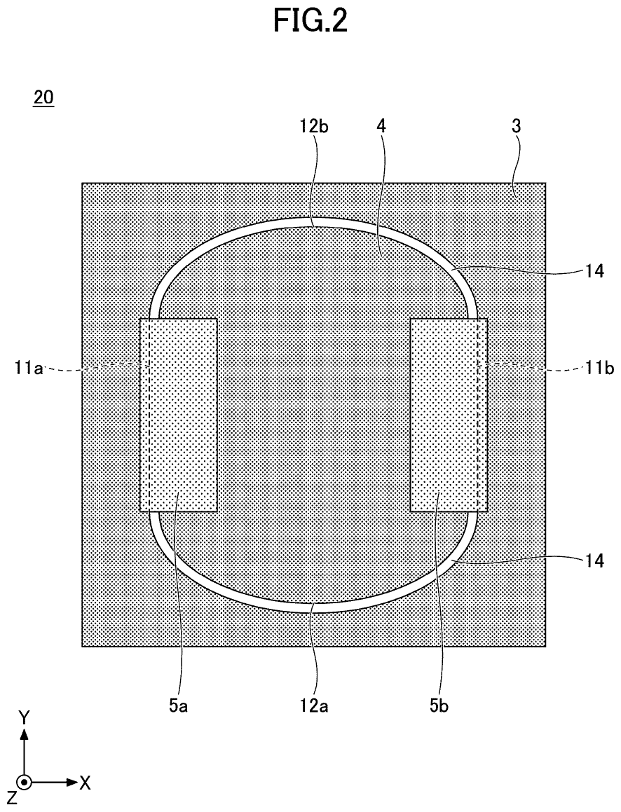

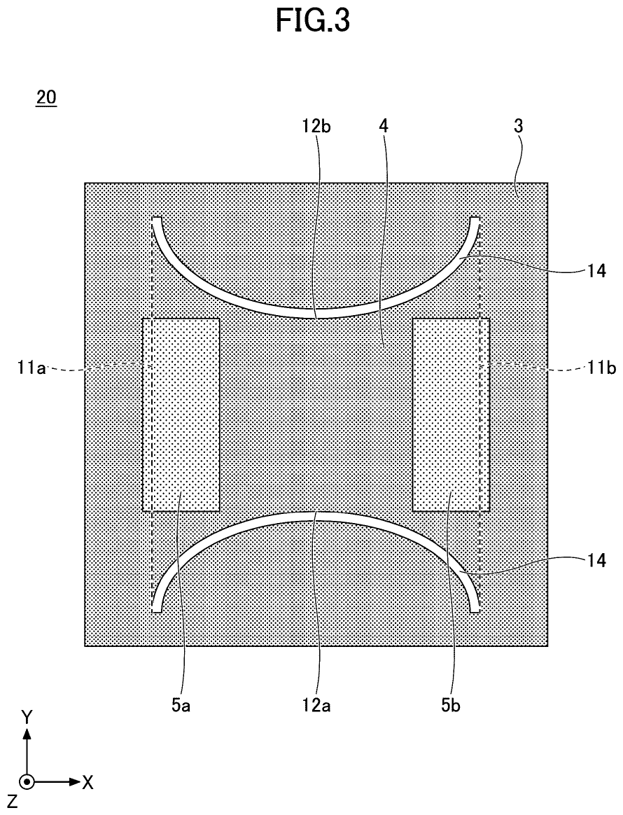

The shape of the vibrating unit 4 is not limited to a square shape, and may be any other polygonal shape or a circular shape. Moreover, as illustrated in FIG. 2 and FIG. 3, part of the vibrating unit 4 may be curve-shaped. Hence, a desired directionality matching the shape of the vibrating unit can be imparted to a sound. For example, when the vibrating unit has a circular shape, a sound pressure distribution having a good symmetric property can be obtained.

The inner rim of the frame 3 need not have a shape conforming to the outer rim of the vibrating unit 4 so long as the frame 3 can enclose the vibrating unit 4. The attaching sides 11 and the open sides 12 may be curves (arcs) In the present embodiment, the entirety of a side of the vibrating unit 4 is attached on the frame 3. However, only a part of a side may be attached.

In other respects, it is preferable that the attaching sides 11a and 11b are opposite two sides, and that the attaching sides 11a and 11b have the same length. Attaching the vibrating unit 4 on the frame 3 with good symmetry in this way can improve vibration stability and can inhibit occurrence of noise during vibration.

The piezoelectric driving unit 5a and the piezoelectric driving unit 5b are examples of the first and second driving units respectively, and are situated on positions overlapping the attaching sides 11a and 11b respectively on the +Z-side surfaces of the frame 3 and the vibrating unit 4.

The piezoelectric driving units 5a and 5b need not be situated on the surface of the frame 3 so long as they are situated to overlap the attaching sides 11a and 11b on the surface of the vibrating unit 4, respectively. However, by situating the piezoelectric driving units 5 to also cover the surface of the frame 3, it is possible to inhibit, for example, peeling or collapse of the piezoelectric driving units 5 that is due to concentration of stress on and about the attaching sides 11a and 11b when the vibrating unit 4 is driven.

The shape of the piezoelectric driving units 5 may be, for example, a polygonal shape other than a rectangular shape, or may be a circular shape, and the piezoelectric driving units 5 need not overlap the entirety of the attaching sides 11a and 11b. However, it is preferable that the piezoelectric driving units 5 are situated to fully cover the attaching sides 11a and 11b, because it is possible to drive the vibrating unit. 4 to a greater degree and to better increase the sound pressure level.

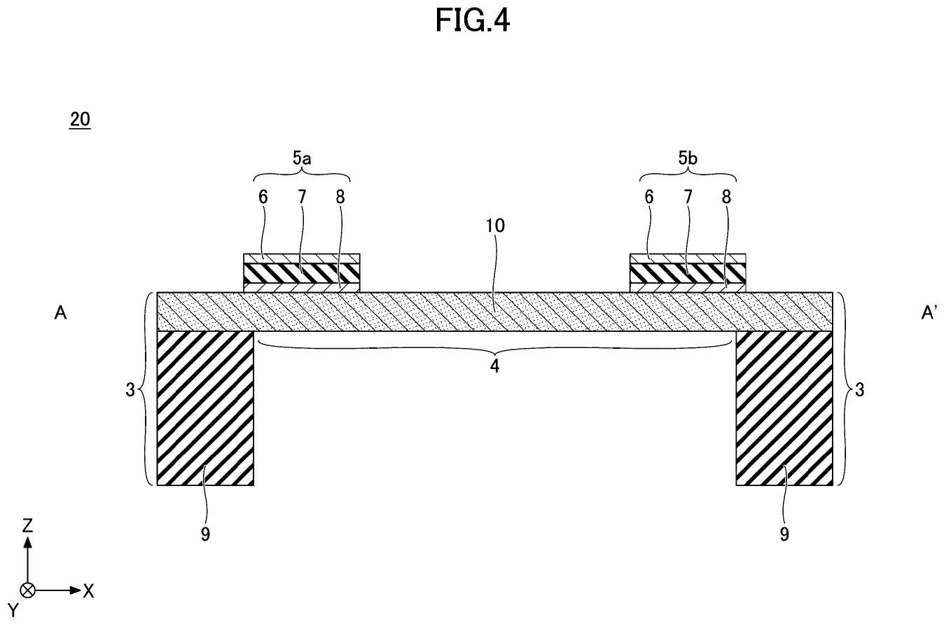

FIG. 4 is a cross-sectional view taken along an alternate long and short dash line A-A′ of FIG. 1. The vibrating unit 4 is made of, for example, a silicon active layer. The thickness (width in the Z axis direction) of the silicon active layer is not particularly limited, but it is more preferable to form the layer with a smaller thickness. When the silicon active layer is formed with a smaller thickness, it is possible to obtain a higher sound pressure level.

A specific thickness of the silicon active layer is preferably 30 μm or less, more preferably 20 μm or less, and yet more preferably 10 μm or less. By varying the dimensions (area on the XY plane) of the silicon active layer in addition to the thickness thereof, it is possible to vary the spring constant of the vibrating unit 4 and implement an intended design of resonance and antiresonance. The vibrating unit 4 is not limited to a silicon active layer, but may be made of, for example, an oxide material, an inorganic material, or an organic material.

The frame 3 includes a silicon active layer 10, and a support layer 9 laminated on a −Z-side surface of the silicon active layer 10. It is possible to form the silicon active layer 10 included in the frame 3 integrally with the Vibrating unit 4, by, for example, processing them by a semiconductor process. The support layer 9 is made of, for example, a single-crystal silicon of an SOI substrate, an inorganic material, or an organic material, and may be formed of a plurality of layers. An interlayer film made of, for example, silicon oxide may be provided at a layer between the silicon active layer 10 and the support layer 9.

The piezoelectric driving units 5a and 5b each include a lower electrode 8, a piezoelectric unit 7, and an upper electrode 6 that are laminated in this order on the 4-Z-side surfaces of the frame 3 and the vibrating unit 4. The lower electrode 8 and the upper electrode 6 are made of, for example, gold (Au) or platinum (Pt). The piezoelectric unit 7 is made of, for example, lead zirconate titanate (PZT), which is a piezoelectric material, but may be made of any other piezoelectric material, and the type of the piezoelectric material does not matter. The piezoelectric driving units 5 may have a structure in which a plurality of piezoelectric units are laminated with an intermediate electrode. The piezoelectric driving units 5 are piezoelectric actuators that are electrically connected to an external control device and are driven by voltage application.

When a voltage is applied to the piezoelectric driving units 5, the piezoelectric units 7 of the piezoelectric driving units 5 are strained in the in-plane direction (XY directions), and the piezoelectric driving units 5, which are unimorphs with respect to the vibrating unit 4, are deformed in the Z axis direction. When the voltage applied to the piezoelectric driving units 5 is changed over time, the surface of the vibrating unit 4 vibrates and generates a pressure wave in the surrounding air. The pressure wave is perceived as a sound by a human. The voltage waveform to be input is a voltage-converted version of the waveform of a sound that is desired to be reproduced. In response to the voltage waveform being input into the piezoelectric driving units 5, the sound is reproduced.

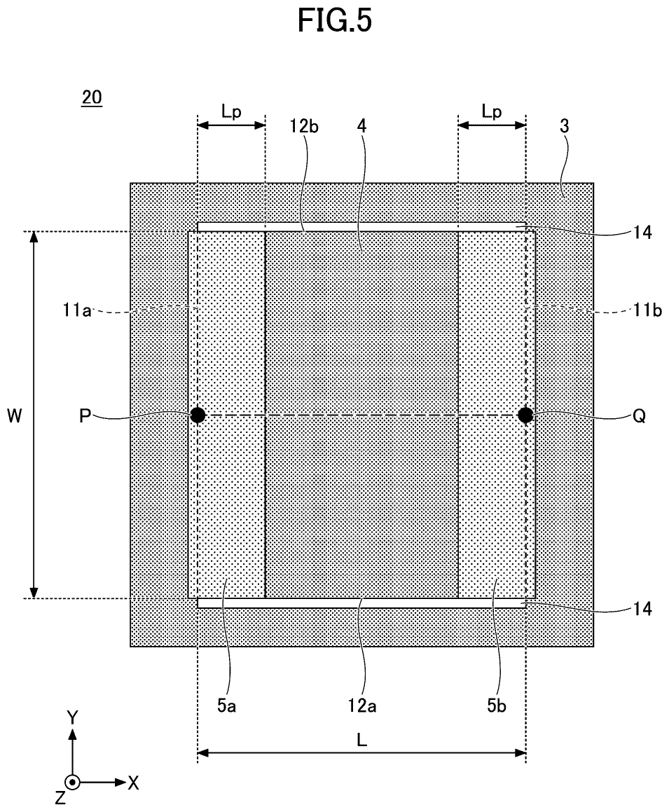

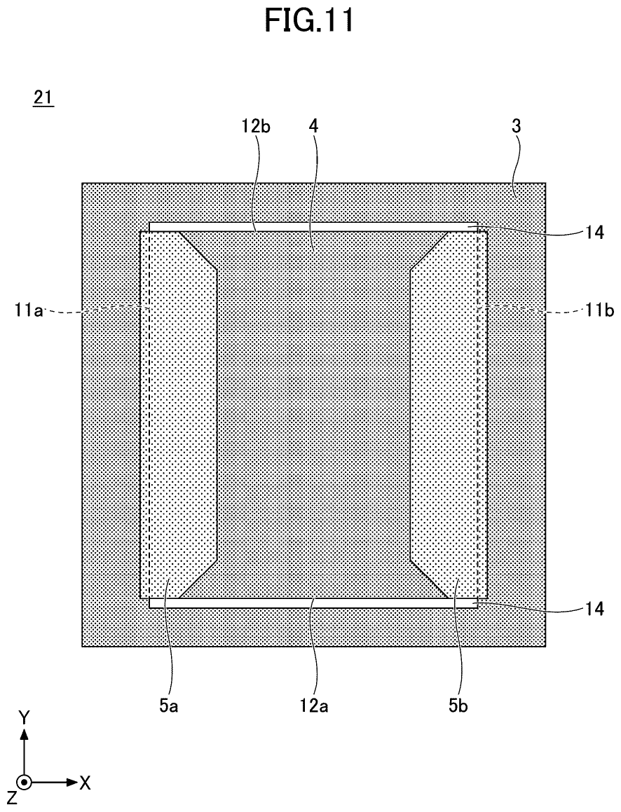

FIG. 5 is a view illustrating shape parameters of the configuration illustrated in FIG. 1. The piezoelectric driving units 5a and 5b according to the present embodiment are situated to overlap the attaching sides 11a and 11b respectively on the +Z-side surfaces of the frame 3 and the vibrating unit 4 as described above. Here, the length of a line segment PQ that connects the midpoint P of the attaching side lie to the midpoint Q of the attaching side Jib is defined as L (hereinafter, referred to as the length L of the vibrating unit), and the width of the vibrating unit 4 in a direction parallel with the Y axis is defined as W (hereinafter, referred to as the width W of the vibrating unit). The length, in a direction parallel with the line segment PQ, of portions of the piezoelectric driving units 5 that are situated to overlap the vibrating unit 4, i.e., the length by which the piezoelectric driving units 5 extend along the X axis from the attaching side 11a or 11b in a direction to the center of the vibrating unit 4 is defined as Lp (hereinafter, referred to as the length Lp of the piezoelectric driving units). When the length Lp assumes different values depending on the measurement positions as illustrated in FIG. 11 described below, the maximum value is referred to as Lp.

In the present embodiment, the piezoelectric driving units 5a and 5b are situated such that a relationship Lp/L between the length L of the vibrating unit and the length Lp of the piezoelectric driving units is 0.35 or less. That is, the length Lp of the piezoelectric driving units is less than or equal to 35% of the length of the line segment PQ.

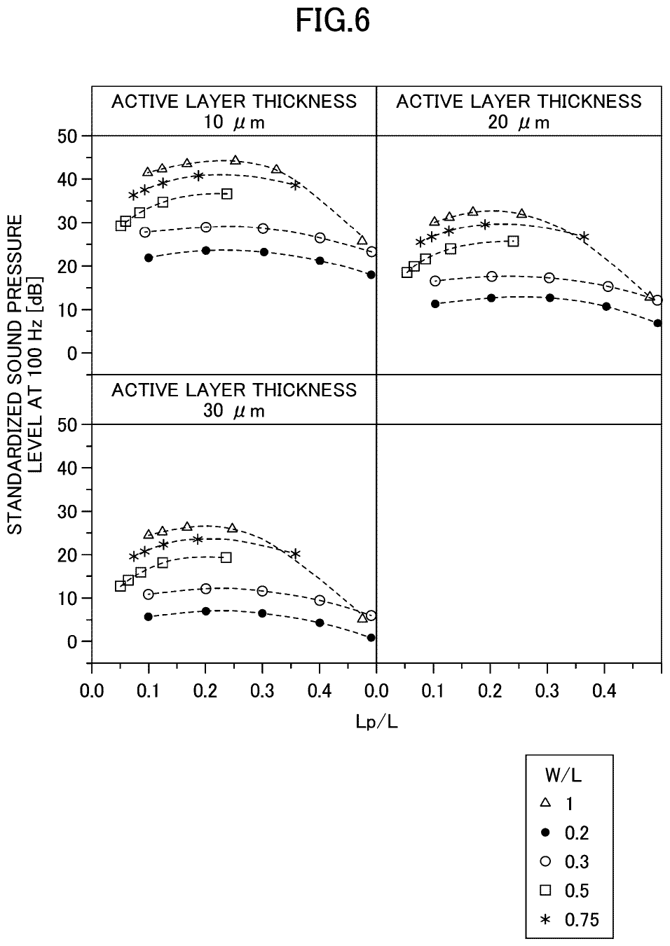

FIG. 6 is a drawing illustrating a relationship between parameters and the sound pressure level according to the present embodiment. The graphs of FIG. 6 illustrate the results of simulation of the relationship between Lp/L and the sound pressure level at an input signal frequency of 100 Hz. Generally speaking, the input signal frequency of 100 Hz is the lowest frequency that is employed in audio device evaluation tests.

The graphs of FIG. 6 illustrate the results of simulation on the conditions that the thickness of the vibrating unit 4 in the Z axis direction (i.e., the thickness of the active layer) is 10 μm, 20 μm, and 30 μm, respectively. Here, the values of the sound pressure level illustrated as the results of simulation are standardized values. The plot in each graph illustrates the result of simulation on the conditions that the aspect ratio W/L of the vibrating unit 4 is 1, 0.75, 0.5, 0.3, and 0.2. Here, the piezoelectric driving unit 5a and the piezoelectric driving unit 5b have the same Lp/L.

As illustrated in FIG. 6, the electroacoustic transducer 2n can obtain a higher sound pressure level at Lp/L of 0.35 or less irrespective of the thickness and the aspect ratio of the vibrating unit 4, and can obtain a higher sound pressure level in a preferable Lp/L range of 0.1 or greater and 0.35 or less. A higher sound pressure level can be obtained in a more preferable Lp/L range of 0.2 or greater and 0.35 or less. A higher sound pressure level can be obtained in a yet more preferable Lp/L range of 0.25 or greater and 0.35 or less. That is, a higher sound pressure level can be obtained when the length Lp of the piezoelectric driving units is greater than or equal to 25% and less than or equal to 35% of the length of the line segment PQ.

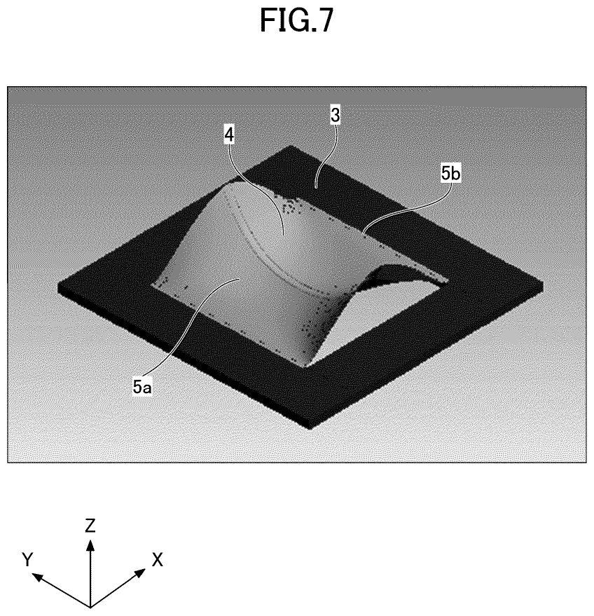

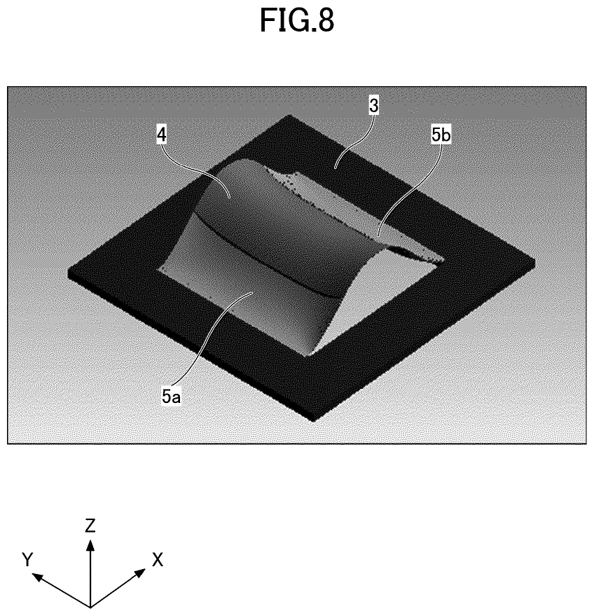

FIG. 1 is a drawing illustrating a behavior of the vibrating unit when Lp/L is 0.49. FIG. 8 is a drawing illustrating a behavior of the vibrating unit when Lp/L is 0.25. As illustrated in FIG. 7, when Lp/L is a value greater than 0.35, the piezoelectric driving units 5a and 5b are not only strained in the X axis direction but also greatly strained in the Y axis direction during driving. Hence, the vibrating unit 4 has different amounts of Z axis direction displacement at about the slits 14 and at about the center, and is deformed in a saddle shape. In this case, the vibration speed of the surface of the vibrating unit 4 decreases, to reduce the volume velocity and hence reduce the sound pressure level.

As compared, as illustrated in FIG. 8, when. Lp/L is a value less than or equal to 0.35, the piezoelectric driving units 5a and Sb are moderately strained in the Y axis direction during driving. Hence, it is possible to inhibit saddle shaped-deformation of the vibrating unit 4, to vibrate the entirety of the vibrating unit 4 efficiently, and to hence increase the sound pressure level.

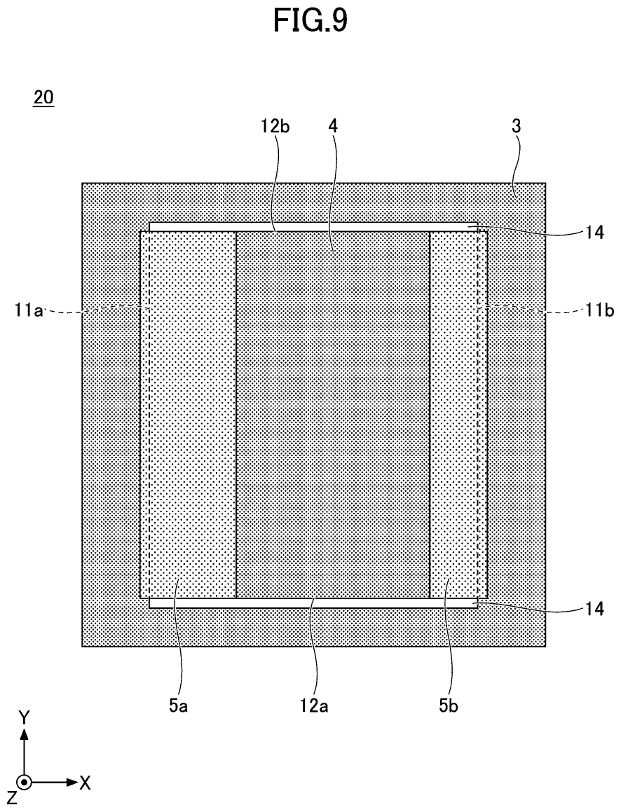

The piezoelectric driving unit 5a and the piezoelectric driving unit 5b may have asymmetric shapes illustrated in FIG. 9, and it is only necessary that either or both of them are provided such that Lp/L is 0.35 or less. The graphs of FIG. illustrate the results of simulation of the relationship between Lp/L and the sound pressure level at an input signal frequency of 100 Hz, on the condition that Lp/L of one of the piezoelectric driving units is 0.49 (Lp/L is greater than 35%).

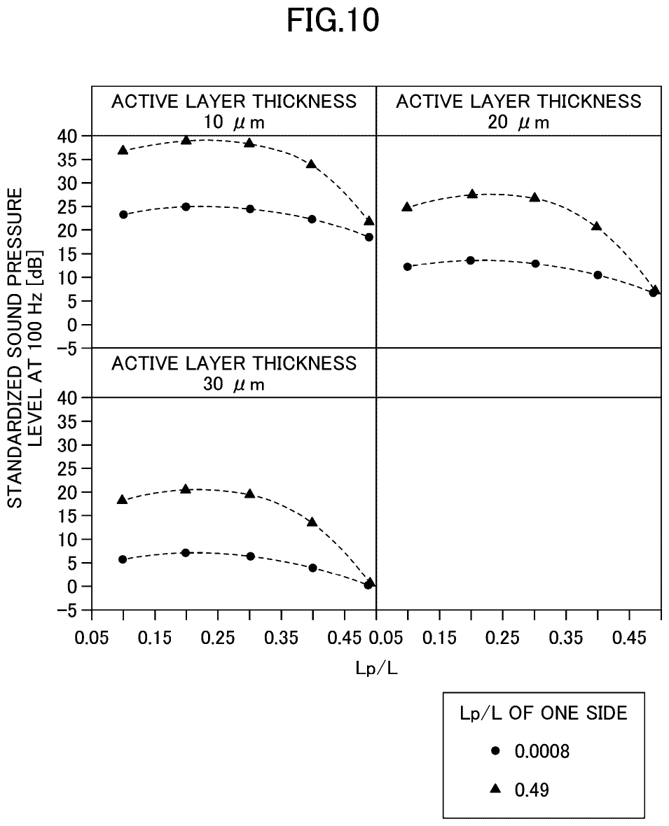

As illustrated in FIG. 10, even when Lp/L of one of the piezoelectric driving units is greater than 35%, a high sound pressure level can be obtained so long as Lp/L of the other piezoelectric driving unit is within a range of 35% or less. Hence, when Lp/L of either or both of the piezoelectric driving units satisfies 35% or less, it is possible to improve the sound pressure level more efficiently. When the piezoelectric driving units 5a and 5b have different Lp/L values, it is possible to reduce the quality factor of the electroacoustic transducer. Hence, it is possible to inhibit an output of a specific frequency from being extremely higher than an output of any other frequency.

### Second Embodiment

Next, a second embodiment will be described with reference to FIG. 11. In the second embodiment, description of any configurational particulars that are the same as those in the embodiment already described may be omitted.

FIG. 11 is a plan view illustrating an example of a configuration of an electroacoustic transducer according to the second embodiment. In an electroacoustic transducer 21 illustrated in FIG. 11, piezoelectric driving units 5a and Sb have a shape different from that in the first embodiment illustrated in FIG. 1. Specifically, the length Lp of each piezoelectric driving unit is varied between a center portion and end portions of the driving unit in a direction perpendicular to the line segment PQ. More specifically, the length Lp of the piezoelectric driving units is shorter near the slits 14 than at and about the center of the piezoelectric driving units 5a and 5b on the Y axis. By the length. Lp of the piezoelectric driving units being shorter at a position closer to the slits 14 than at and about the center of the piezoelectric driving units 5a and Sb on the Y axis, the vibrating unit 4 tends not to deform in a saddle shape. Hence, it is possible to better stabilize and increase the sound pressure level.

### Third Embodiment

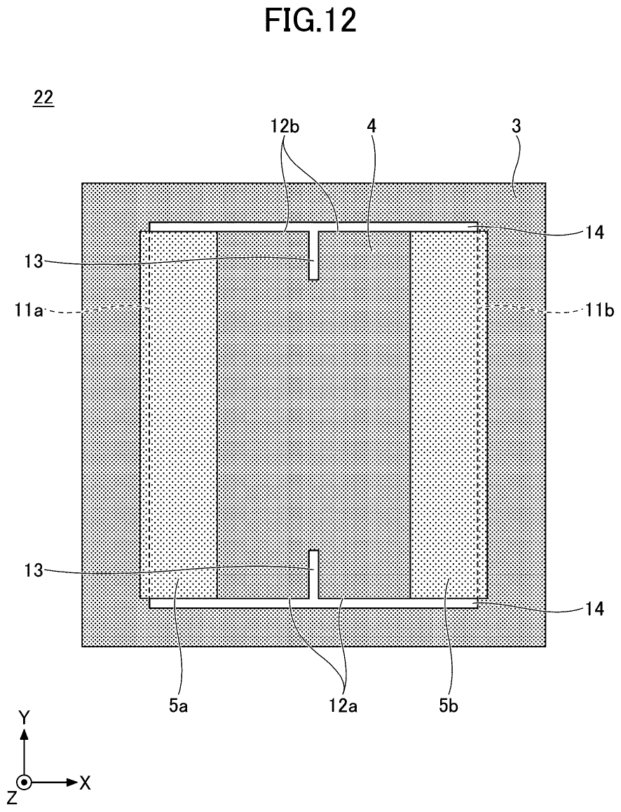

Next, a third embodiment will be described with reference to FIG. 12 to FIG. 14.

FIG. 12 is a plan view illustrating an example of a configuration of an electroacoustic transducer according to a third embodiment. An electroacoustic transducer 22 illustrated in FIG. 12 is different from the first embodiment illustrated in FIG. 1 in that the vibrating unit 4 has cut portions 13. The cut portions 13 are situated to mirror each other across the vibrating unit 4, and extend in a direction parallel with the Y axis.

In a plan view perspective, the cut portions 13 are open to the open sides 12a and 12b, and each have one or a plurality of sides connecting to the open side 12a or 12b. Here, if the open side 12a, which, in the first embodiment illustrated in FIG. 1, is a single side because of having no cut portion 13, is separated into a plurality of sides by the cut portion 13, the separate sides are collectively referred to as open sides 12a.

In the example of FIG. 12, the cut portions 13 each have: two sides that extend in a direction parallel with the Y axis, face each other, and connect to the open side 12a or 12b at one of their ends; and one side that connects to the opposite ends of the two sides and extends in a direction parallel with the X axis. However, the extending direction of the cut portions 13 is not limited to the example of FIG. 12. The extending direction of the cut portions 13 need only be a direction intersecting with the line segment PQ, and it is preferable that the cut portions 13 extend in a direction to the center of the vibrating unit 4.

Moreover, as illustrated in FIG. 12, when the electroacoustic transducer has slits 14, it is preferable to provide the cut portions 13 to be continuous with the slits 14. When the vibrating unit 4 has the cut portions 13, it is possible to improve the sound pressure level more efficiently because the stiffness of the vibrating unit 4 against bending is reduced.

### First Modified Example of the Third Embodiment

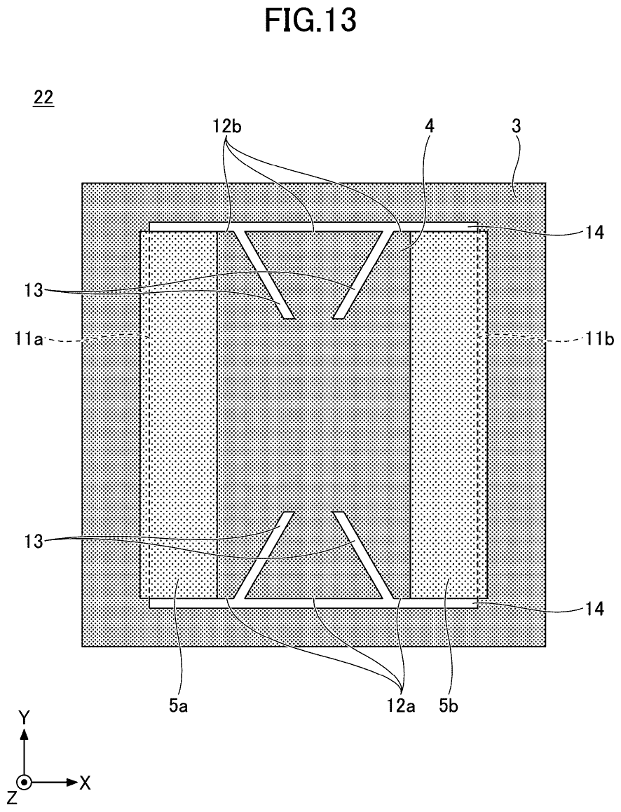

FIG. 13 illustrates a first modified example of the third embodiment. In the first modified example illustrated in FIG. 13, a plurality of cut portions 13 extend from each of the open sides 12a and 12b in directions to the center of the vibrating unit 4. By providing a plurality of cut portions from each open side in this way, it is possible to improve the sound pressure level more efficiently because the stiffness of the vibrating unit 4 against bending is reduced. Moreover, by adjusting the number of cut portions provided on each open side, it is possible to adjust the resonance frequency of the vibrating unit 4, and to obtain a desired frequency property.

### Second Modified Example of the Third Embodiment

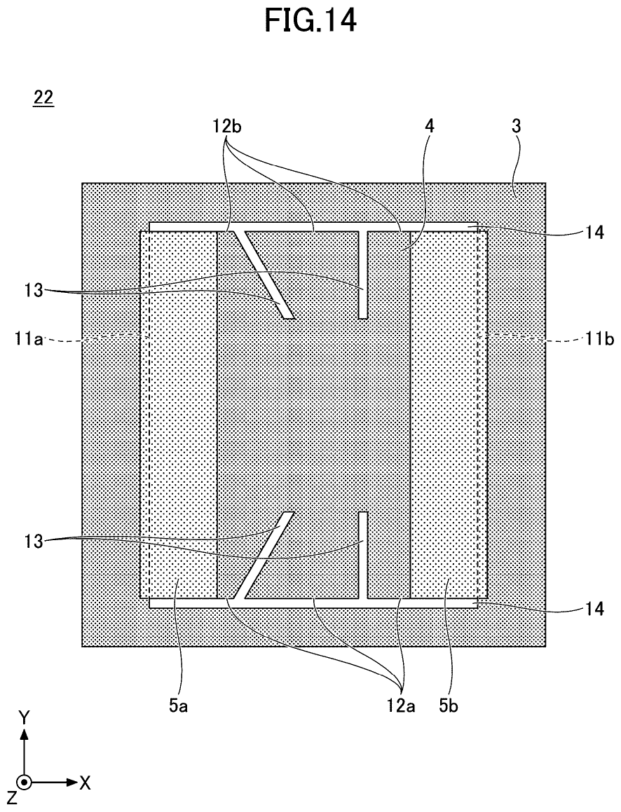

FIG. 14 is a plan view illustrating a second modified example of the third embodiment. In the second modified example illustrated in FIG. 14, the vibrating unit 4 has a plurality of cut portions 13 varied in the extending direction or the width. The cut portions that start from the open side 12a and the cut portions that start from the open side 12b may be asymmetric.

As described, it is possible to appropriately adjust the number, width, extending direction, and positioning of the cut portions to be provided in the vibrating unit 4 at the production phase. This makes it possible to adjust the resonance frequency of the vibrating unit 4, and to hence obtain a desired frequency property. The cut portions are not limited to a linear shape, and may have a curve shape. When providing a plurality of cut portions, a cut portion having a straight line shape and a cut portion having a curve shape may coexist. A portion having a straight line shape and a portion having a curve shape may coexist in one cut portion.

### Fourth Embodiment

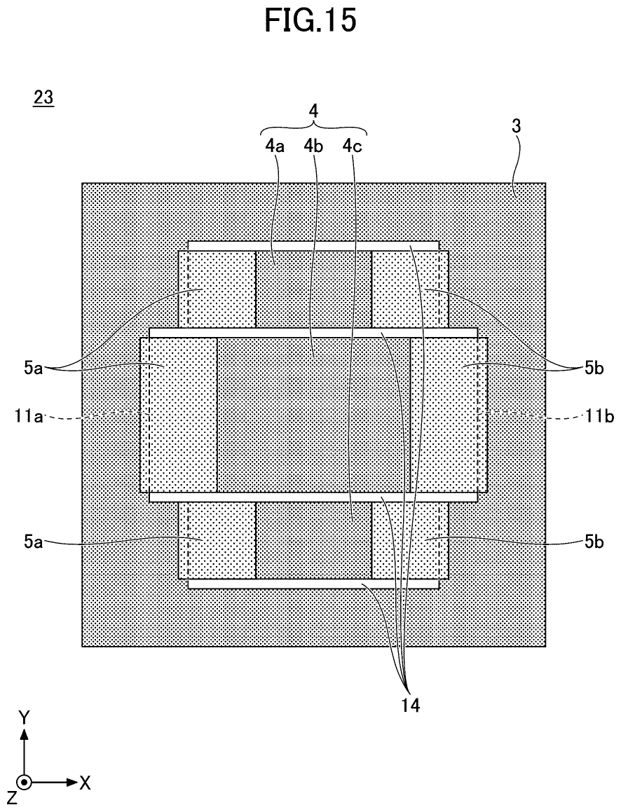

Next, a fourth embodiment will be described with reference to FIG. 15 to FIG. 19.

FIG. 15 is a plan view illustrating an example of a configuration of an electroacoustic transducer according to the fourth embodiment. An electroacoustic transducer 23 illustrated in FIG. 15 includes a plurality of vibrating units 4a to 4c in the Y axis direction. The vibrating units 4a to 4c are provided with gaps between themselves, and are positioned separately from each other by slits 14. The width W and the length L of the vibrating unit 4a are the same as those of the vibrating unit 4c. The width W and the length L of the vibrating units 4a and 4c are different from those of the vibrating unit 4b. The width of a frame 3 in the X axis direction is varied depending on the positions at which the respective vibrating units are situated, in accordance with the lengths L of the vibrating units 4a to 4c. By adjusting internal dimensions of the frame 3 in this way, it is possible to situate each vibrating unit.

As in the first embodiment, piezoelectric driving units 5a and Sb are situated on the +Z-side surfaces of the frame 3 and the vibrating units 4a to 4c such that the piezoelectric driving units overlap respective attaching sides. When the electroacoustic transducer includes a plurality of vibrating units as described, by varying the width W and the length L between the vibrating units, it is possible to realize a configuration including the vibrating units varied in the resonance frequency and the frequency property.

Hence, one electroacoustic transducer suffices to output a high sound pressure level over a broader band. At the same time, it is possible to provide an electroacoustic transducer having a smaller size than that of an electroacoustic transducer that can output the same band. The number of vibrating units, and the width P or the length L of each vibrating unit may be appropriately changed at the design phase. Hence, there may be two or more values which the respective vibrating units may have as the width P or the length L, or all vibrating units may be the same.

### First Modified Example of the Fourth Embodiment

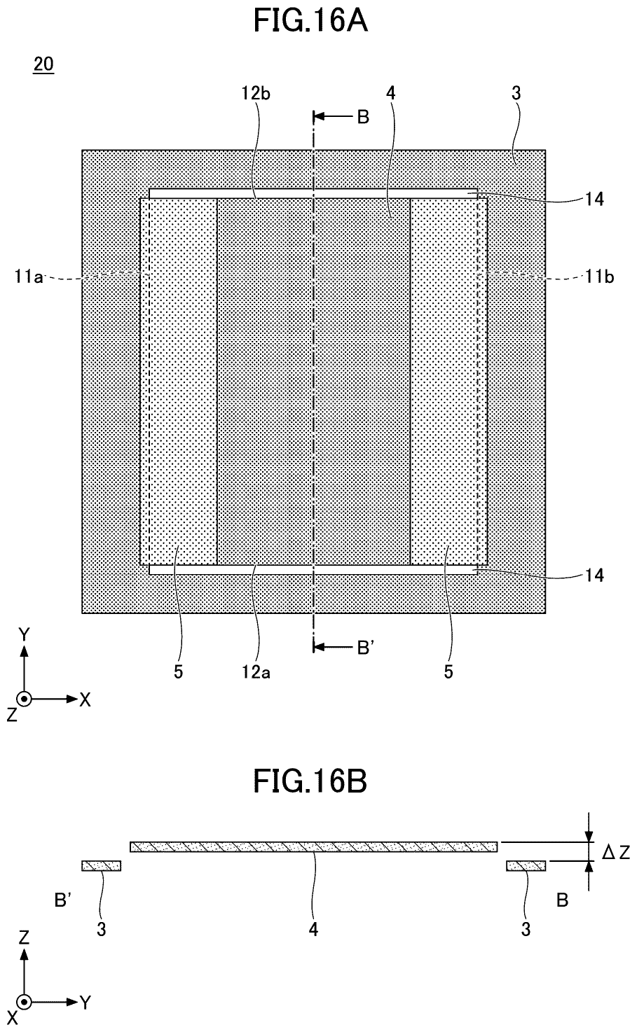

FIG. 16A is a plan view illustrating an example of the configuration of the electroacoustic transducer according to the first embodiment. FIG. 16B is a cross-sectional view taken along an alternate long and short dash line B-B of FIG. 16A. In the case of the configuration for vibrating one vibrating unit 4 in the Z axis direction as in the first embodiment illustrated in FIG. 16A, a displacement ΔZ in the Z axis direction occurs between the vibrating unit 4 and the frame 3 during driving as illustrated in FIG. 16B. The displacement ΔZ between the vibrating unit 4 and the frame 3 causes air resistance between the open sides 12a and 12b and the frame 3, and the air resistance may disturb the vibration of the vibrating unit 4. According to the present modified example, for example, it is possible to make the vibrating unit easier to drive, by inhibiting increase in the air resistance occurring along with the vibration of the vibrating unit.

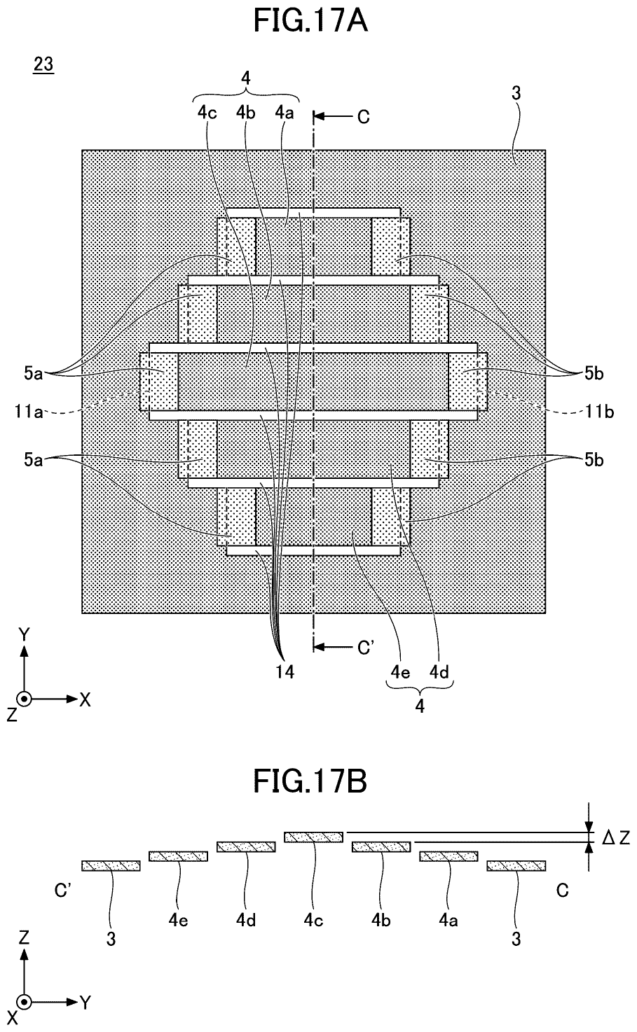

FIG. 17A is a plan view illustrating a first modified example of the fourth embodiment. FIG. 17B is a cross-sectional view taken along an alternate long and short dash line C-C′ of FIG. 17A. In the first modified example illustrated in FIG. 17A, the lengths L of the vibrating units are in the descending order from the vibrating unit 4c that is positioned at the center in the direction perpendicular to the line segment Pc). That is, the vibrating unit 4c positioned at the center on the y axis has the maximum length L, and the vibrating units 4 farther from the vibrating unit 4c in the ±Y directions have a shorter length L.

When the vibrating units 4 are positioned such that the lengths L of the vibrating units are in the descending order from the vibrating unit 4c to the ±Y directions, the resonance frequencies of the respective vibrating units are in the ascending order from the vibrating unit 4c to the ±Y directions. Hence, when the vibrating units are vibrated, the difference as the displacement ΔZ in the Z axis direction from the adjoining vibrating unit or from the adjoining frame can be better reduced as illustrated in FIG. 17B. Hence, it is possible to reduce the air resistance that occurs between the vibrating units or between a vibrating unit and the frame, and to make the vibrating units easier to drive.

In the present modified example, the configuration in which the number of the vibrating units 4 is an odd number and the lengths L of the vibrating units are in the descending order from the vibrating unit positioned at the center on the Y axis has been described as a preferable mode. However, this configuration is non-limiting. For example, the vibrating units may be positioned such that the lengths L of the vibrating units are in the descending order from a vibrating unit that is not positioned at the center on the F axis.

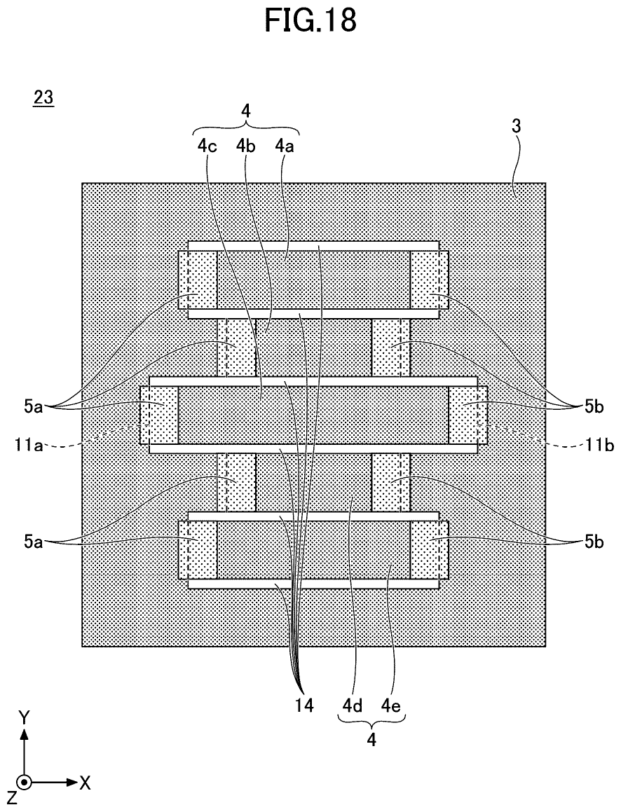

In a second modified example of the fourth embodiment illustrated in FIG. 18, the lengths L of the vibrating units are in the descending order from the vibrating unit 4a to the vibrating unit 4b. Likewise, the lengths L of the vibrating units are in the descending order from the vibrating unit 4e to the vibrating unit 4d.

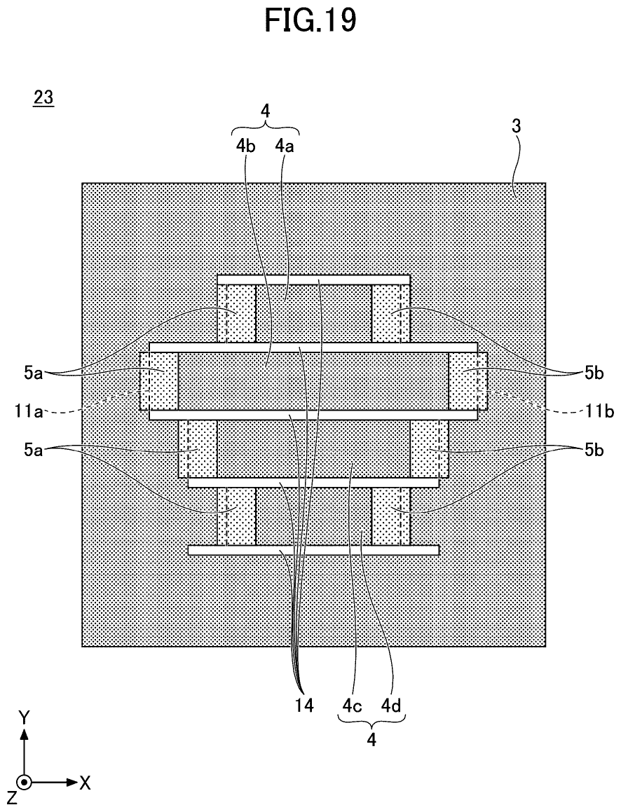

In a third modified example of the fourth embodiment illustrated in FIG. 19, an even number of vibrating units are positioned. The number of vibrating units, among the positioned vibrating units 4, which are positioned in the +Y direction from the vibrating unit 4b that has the maximum vibrating unit length L is different from the number of vibrating units positioned in the −Y direction from the vibrating unit 4b.

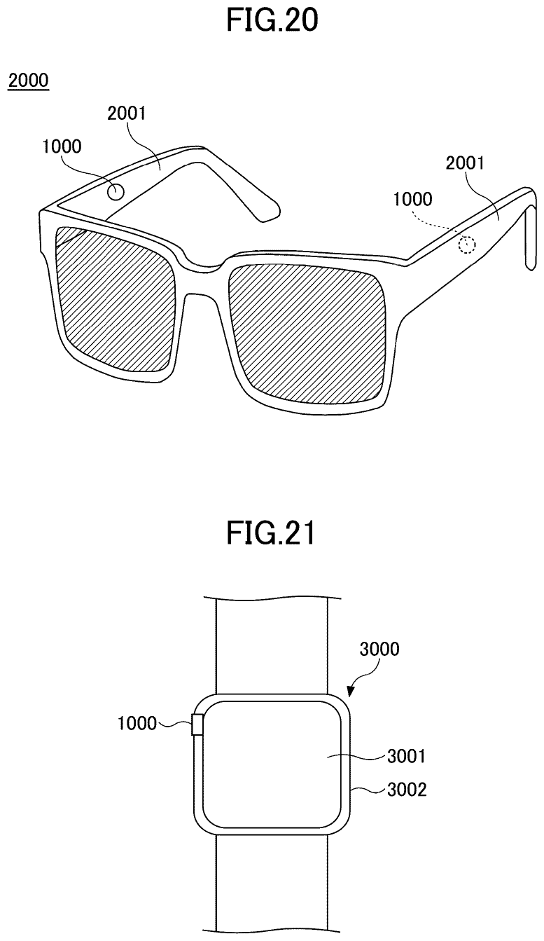

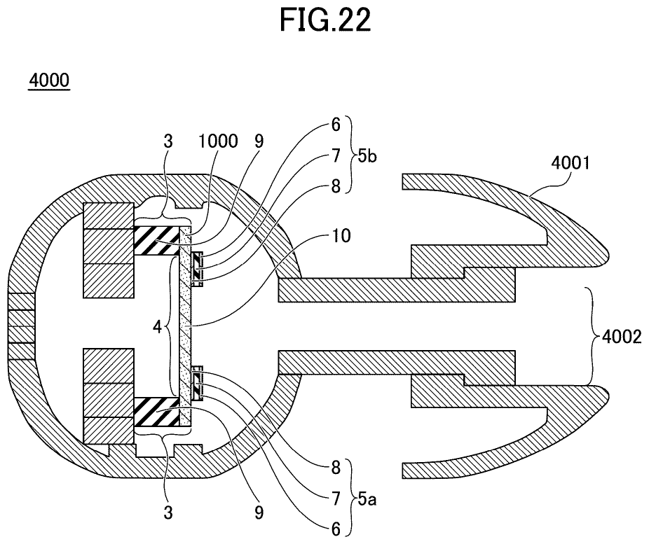

The first to fourth embodiments described above can be applied not only to an electroacoustic transducer, but to audio instruments including an electroacoustic transducer, such as earphones, a headphone, and a loudspeaker. Moreover, the first to fourth embodiments may be used while being embedded as, for example, an audio instrument in wearable devices that can be worn directly or indirectly on the body of a user, such as wristwatch type, eyeglasses-type, Head Mounted Display (HMD) type, and body mounted-type devices. For example, when mounting a loudspeaker 1000 on an eyeglasses-type wearable device 2000, it is preferable to position the loudspeaker 1000 on the internal surface (the surface facing the user during wearing) of a temple 2001 as illustrated in FIG. 20. Moreover, for example, when mounting a loudspeaker 1000 on a wristwatch-type wearable device 3000, it is preferable to position the loudspeaker 1000 on a circumference 3002 of a liquid crystal screen 3001 as illustrated in FIG. 21. Moreover, for example, when mounting a loudspeaker 1000 on an earphone 4000, it is preferable that an opening portion 4002 of an attachment portion. 4001 to be attached on an ear is positioned in the direction normal to the vibrating plate of the loudspeaker 1000 as illustrated in FIG. 22.

### Supplemental to Embodiments

The electroacoustic transducer according to an embodiment of the present invention has been described so far. However, the embodiment described above is non-limiting, and may be changed within a range of conception of a person skilled in the art by, for example, addition of other embodiments, changes, or deletions. Any mode is included within the scope of the present invention so long as the mode has the workings and effects of the present invention.

### (First Aspect.)

An electroacoustic transducer as a first aspect includes: a vibrating unit; a plurality of driving units situated on the vibrating unit and configured to drive the vibrating unit; and a frame positioned along a circumference of the vibrating unit in a plan view perspective,
wherein in the plan view perspective, the vibrating unit is attached on the frame by a first attaching side thereof and a second attaching side thereof facing the first attaching side,
the driving units include a first driving unit situated at a position overlapping the first attaching side, and a second driving unit situated at a position overlapping the second attaching side, and
a length of the first driving unit on the vibrating unit in a direction parallel with a line segment that connects a midpoint of the first attaching side and a midpoint of the second attaching side is less than or equal to 35% of a length of the line segment.

### (Second Aspect)

An electroacoustic transducer as a second aspect is based on the first aspect and characterized in that a length of the second driving unit on the vibrating unit in the direction parallel with the line segment is less than or equal to 35% of the length of the line segment.

### (Third Aspect)

An electroacoustic transducer as a third aspect is based on the first aspect or the second aspect and characterized in that a length of one or both of the first driving unit and the second driving unit on the vibrating unit in the direction parallel with the line segment is greater than or equal to 25% of the length of the line segment.

### (Fourth Aspect)

An electroacoustic transducer as a fourth aspect is based on any one of the first aspect to the third aspect and characterized in that one or both of the first driving unit and the second driving unit are situated at positions overlapping the frame.

### (Fifth Aspect)

An electroacoustic transducer as a fifth aspect is based on any one of the first aspect to the third aspect and characterized in that the length of the driving units in the direction parallel with the line segment is varied between a center portion and end portions of the driving units in a direction perpendicular to the direction parallel with the line segment.

### (Sixth Aspect)

An electroacoustic transducer as a sixth aspect is based on the fifth aspect and characterized in that the length of the driving units in the direction parallel with the line segment is shorter at the end portions than at the center portion of the driving units in the direction perpendicular to the direction parallel with the line segment.

### (Seventh Aspect)

An electroacoustic transducer as a seventh aspect is based on any one of the first aspect to the sixth aspect and includes a cut portion in a direction intersecting with the line segment.

### (Eighth Aspect)

An electroacoustic transducer as an eighth aspect is based on any one of the first aspect to the seventh aspect and includes a slit between the vibrating unit and the frame, the slit extending in a direction intersecting with the first attaching side and the second attaching side.

### (Ninth Aspect)

An electroacoustic transducer as a ninth aspect is based on any one of the first aspect to the eighth aspect and characterized in that the slit contacts the first attaching side and the second attaching side.

### (Tenth Aspect)

An electroacoustic transducer as a tenth aspect is based on any one of the first aspect to the ninth aspect and includes a plurality of vibrating units separate from each other in a direction intersecting with the line segment, each vibrating unit of the plurality of vibrating units being the vibrating unit.

### (Eleventh Aspect)

An electroacoustic transducer as an eleventh aspect is based on the tenth aspect and characterized in that there are two or more values as the length of the line segment in the plurality of vibrating units.

### (Twelfth Aspect)

An electroacoustic transducer as a twelfth aspect is based on the tenth aspect Cr the eleventh aspect and characterized in that there are two or more values as lengths of the plurality of vibrating units in a direction perpendicular to the line segment.

### (Thirteenth Aspect)

An electroacoustic transducer as a thirteenth aspect is based on any one of the tenth aspect to the twelfth aspect and characterized in that the length of the line segment in the plurality of vibrating units is in a descending order from the vibrating unit that is positioned at a center in a direction perpendicular to the line segment.

### (Fourteenth Aspect)

An electroacoustic transducer as a fourteenth aspect includes: a vibrating unit; and a plurality of driving units configured to drive the vibrating unit,
wherein the plurality of driving units are situated at positions overlapping at least a part of a first side of the vibrating unit or a second side of the vibrating unit facing the first side; and
a length of the driving units in a direction parallel with a line segment that connects midpoints of the first side and the second side is less than or equal to 35% of the line segment.

### (Fifteenth Aspect)

An electroacoustic transducer as a fifteenth aspect is based on the fourteenth aspect and includes a frame supporting the vibrating unit,
wherein the frame is attached on the first side and the second side.

### (Sixteenth Aspect)

An electroacoustic transducer as a sixteenth aspect is based on the fifteenth aspect and characterized in that a side of the vibrating unit different from the first side and the second side is separate from the frame in a plan view perspective.

### (Seventeenth Aspect)

An audio instrument as a seventeenth aspect includes the electroacoustic transducer of any one of the first aspect to the sixteenth aspect.

### (Eighteenth Aspect)

A wearable device as an eighteenth aspect includes the electroacoustic transducer of any one of the first aspect to the sixteenth aspect.

1. An electroacoustic transducer comprising:
a vibrating plate,
a plurality of multilayered driver structures situated on the vibrating plate and configured to drive the vibrating plate; and
a frame positioned along a circumference of the vibrating plate in a plan view perspective,
wherein in the plan view perspective, the vibrating plate is attached on the frame by a first attaching side thereof and a second attaching side thereof facing the first attaching side,
the multilayered driver structures include a first multilayered driver structure situated at a position overlapping the first attaching side, and a second multilayered driver structure situated at a position overlapping the second attaching side, and
a length of the first multilayered driver structure on the vibrating plate in a direction parallel with a line segment that connects a midpoint of the first attaching side and a midpoint of the second attaching side is less than or equal to 35% of a length of the line segment.

2. The electroacoustic transducer according to claim 1,
wherein a length of the second multilayered driver structure on the vibrating plate in the direction parallel with the line segment is less than or equal to 35% of the length of the line segment.

3. The electroacoustic transducer according to claim 1,
wherein a length of one or both of the first multilayered driver structure and the second multilayered driver structure on the vibrating plate in the direction parallel with the line segment is greater than or equal to 25% of the length of the line segment.

4. The electroacoustic transducer according to claim 1,
wherein one or both of the first multilayered driver structure and the second multilayered driver structure are situated at positions overlapping the frame.

5. The electroacoustic transducer according to claim 1,
wherein the length of the multilayered driver structures in the direction parallel with the line segment is varied between a center portion and end portions of the multilayered driver structures in a direction perpendicular to the direction parallel with the line segment.

6. The electroacoustic transducer according to claim 5,
wherein the length of the multilayered driver structures in the direction parallel with the line segment is shorter at the end portions than at the center portion of the multilayered driver structures in the direction perpendicular to the direction parallel with the line segment.

7. The electroacoustic transducer according to claim 1, comprising:
wherein the vibrating plate has a cut portion in a direction intersecting with the direction parallel with the line segment.

8. The electroacoustic transducer according to claim 1, comprising:
a slit between the vibrating plate and the frame, the slit extending in a direction intersecting with the first attaching side and the second attaching side.

9. The electroacoustic transducer according to claim 8,
wherein the slit contacts the first attaching side and the second attaching side.

10. The electroacoustic transducer according to claim 1, comprising:
a plurality of vibrating plates separate from each other in a direction intersecting with the line segment, each vibrating plate of the plurality of vibrating plates being the vibrating plate.

11. The electroacoustic transducer according to claim 10, wherein there are two or more values as the length of the line segment in the plurality of vibrating plates.

12. The electroacoustic transducer according to claim 10,
wherein there are two or more values as lengths of the plurality of vibrating plates in a direction perpendicular to the line segment.

13. The electroacoustic transducer according to claim 10,
wherein the length of the line segment in the plurality of vibrating plates is in a descending order from the vibrating plate that is positioned at a center in a direction perpendicular to the line segment.

14. An electroacoustic transducer comprising:
a vibrating plate; and
a plurality of multilayered driver structures configured to drive the vibrating plate;
wherein the plurality of multilayered driver structures are situated at positions overlapping at least a part of a first side of the vibrating plate or a second side of the vibrating plate facing the first side; and
a length of the multilayered driver structures in a direction parallel with a line segment that connects midpoints of the first side and the second side is less than or equal to 35% of the line segment.

15. The electroacoustic transducer according to claim 14, comprising:
a frame supporting the vibrating plate,
wherein the frame is attached on the first side and the second side.

16. The electroacoustic transducer according to claim 15,
wherein a side of the vibrating plate different from the first side and the second side is separate from the frame in a plan view perspective.

17. An audio instrument comprising:
the electroacoustic transducer of claim 1.

18. A wearable device comprising:
the electroacoustic transducer of claim 1.
